(19) United States
(12) Patent Application Publication
(10) Pub. No.: US 2026/0339311 A1
(43) Pub. Date: Oct. 29, 2026

(54) INFORMATION PROCESSING APPARATUS

(71) Applicant: FANUC CORPORATION, Yamanashi (JP)

(72) Inventor: Ryo HINATA, Yamanashi (JP)

(21) Appl. No.: 18/995,154

(22) PCT Filed: Sep. 6, 2022
(86) PCT No.: PCT/JP2022/033486

§ 371 Date: Jan. 16, 2025

(51) Int. Cl. G05B 23/02

(52) U.S. Cl. CPC G05B 23/0272

(57) ABSTRACT

An object is to reduce the amount of work for making an inquiry to an external party by the user to resolve an abnormality in an industrial machine when such an abnormality occurs. An information processing apparatus according to the present embodiment is connected to an industrial machine such as a robot in such a manner that data communication is possible. The information processing apparatus includes a monitoring unit for monitoring the occurrence of an abnormal situation of the industrial machine, and a processing unit for executing a support process of supporting an inquiry by the user when an abnormality of the industrial machine is detected.

### RELATED APPLICATIONS

The present application is a National Phase of International Application No. PCT/JP2022/033486 filed Sep. 6, 2022.

The present invention relates to an information processing apparatus having a function of monitoring an industrial machine such as a robot.

### BACKGROUND ART

As robots are increasingly introduced into production plants and the like, the technology for monitoring the introduced robots is becoming increasingly important. For example, a robot monitoring system can perform predictive maintenance using an algorithm for predicting a failure, preventive maintenance for notifying a replacement time of an object, such as a battery, that has a predetermined replacement time, and operation monitoring for confirming the operation status of the robot, and can notify a system administrator when an abnormality occurs (for example, Patent Literature 1). Some robot monitoring systems are built with so-called on-premise systems, in which a closed network is built between one or more robots and a robot monitoring system server and operated without connection to an external network.

### CITATION LIST

### Patent Literature

Patent Literature 1: Japanese Unexamined Patent Application Publication No. 2015-131381

### SUMMARY

### Problem to Be Solved

In a robot monitoring system constituted by an on-premise system, even if an abnormality is detected on the system, it is not possible to make an inquiry to the maintenance company of the robot via an external network, at least from the devices constituting the robot monitoring system, because the system is not connected to the external network. Therefore, the user needs to make an inquiry to the maintenance company of the robot, using a terminal connected to the external network. In the inquiry, the user must download an inquiry form prepared by the maintenance company from a web site of the maintenance company, and enter the inquiry items. However, it is troublesome to check and enter the inquiry items one by one, and in some cases, it is necessary to go to the robot where an abnormality has occurred and confirm the base information embedded in the robot, making it impossible to respond quickly when an abnormality occurs in the robot. Therefore, it is desired to reduce the amount of work for making an inquiry to an external party by the user.

### Solution to Problem

An information processing apparatus according to the present disclosure is an information processing apparatus connected to an industrial machine, including: a monitoring unit for monitoring the occurrence of an abnormal situation of the industrial machine: and a processing unit for executing a support process of supporting an inquiry by a user when an abnormality of the industrial machine is detected.

### BRIEF DESCRIPTION OF THE DRAWINGS

FIG. 1 shows a robot monitoring system including an information processing apparatus according to the present embodiment.

FIG. 2 is a hardware configuration diagram of the information processing apparatus shown in FIG. 1.

FIG. 3 is a functional block diagram of the information processing apparatus shown in FIG. 1.

FIG. 4 is a flowchart showing a procedure of robot monitoring processing by the information processing apparatus shown in FIG. 1.

FIG. 5 shows an example of a setting screen displayed on the information processing apparatus shown in FIG. 1.

FIG. 6 shows an example of a home screen displayed on the information processing apparatus shown in FIG. 1.

FIG. 7 shows an example of a notification screen displayed on the information processing apparatus shown in FIG. 1.

FIG. 8 shows an example of a diagnosis result screen displayed on the information processing apparatus shown in FIG. 1.

FIG. 9 shows an example of a detail screen of a mechanical diagnosis displayed on the information processing apparatus of FIG. 1.

FIG. 10 shows an example of a confirmation screen of the deterioration state of a reducer displayed on the information processing apparatus shown in FIG. 1.

FIG. 11 shows an example of an inquiry screen displayed on a user terminal 21 that has read a two-dimensional code displayed on the notification screen shown in FIG. 7.

FIG. 12 shows an example of a robot state confirmation screen displayed on the information processing apparatus shown in FIG. 1.

FIG. 13 is a functional block diagram of an information processing apparatus according to a modification of the present embodiment.

FIG. 14 shows an example of a two-dimensional code issuance screen displayed on the information processing apparatus shown in FIG. 13.

### DETAILED DESCRIPTION

Hereinafter, an information processing apparatus according to the present embodiment will be described with reference to the drawings. In the following description, constituent elements having substantially the same function and configuration are denoted by the same reference numeral, and repetitive descriptions will be given only where necessary.

The information processing apparatus according to the present embodiment is a computer apparatus having a function of monitoring the occurrence of an abnormal situation of an industrial machine and a function of supporting an inquiry by a user concerning the resolution of the abnormal situation. In the present embodiment, a robot apparatus is described as an example of the industrial machine. However, the industrial machine may be a machine tool, a welding apparatus, or the like, and is not limited to a robot. Typically, the information processing apparatus according to the present embodiment is configured as follows.

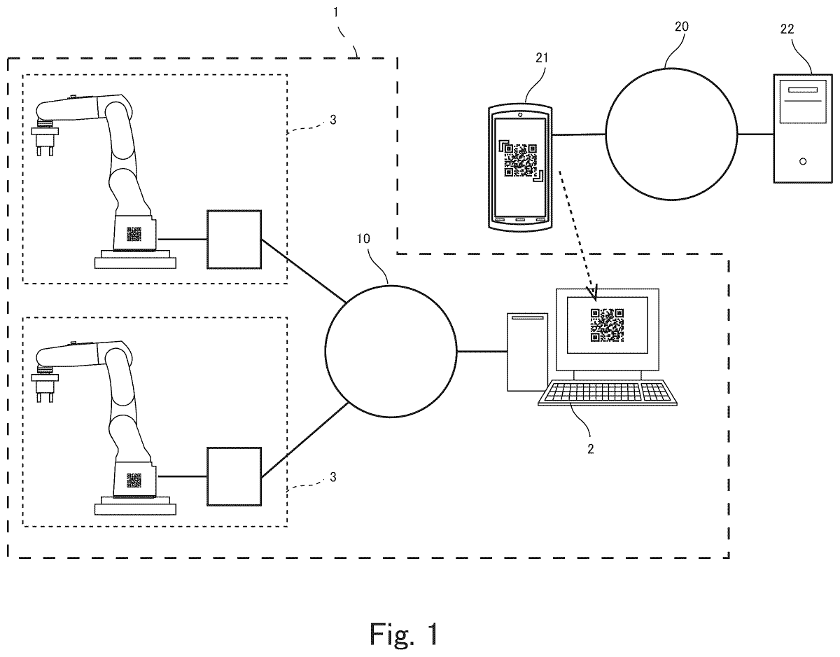

An information processing apparatus 2 according to the present embodiment is configured on an on-premise environment. Typically, as shown in FIG. 1, the information processing apparatus 2 according to the present embodiment constitutes an on-premise monitoring system 1 together with a plurality of robots 3 to be monitored. That is, the information processing apparatus 2 according to the present embodiment is connected to the plurality of robots 3 directly or through an internal network 10 in such a manner that data communication is possible. On the other hand, the information processing apparatus 2 according to the present embodiment is not connected to an external network 20 such as the Internet in such a manner that data communication is possible. Therefore, even if the information processing apparatus 2 detects that an abnormal situation has occurred in a robot 3, the information processing apparatus 2 cannot transmit inquiry information for resolving the abnormal situation to an external server apparatus 22 of an inquiry destination.

Therefore, one feature of the information processing apparatus 2 according to the present embodiment is that it has a function of storing image data of a code in which information on the monitored robot 3 (hereinafter simply referred to as robot information) is recorded, and a function of displaying the image data as an image. The code is a pattern that can be read by an information processing terminal such as a smartphone and is provided by a bar code, a QR code (registered trademark), or the like. In the present embodiment, it will be described as a two-dimensional code.

Typically, the two-dimensional code records, as robot information, information that allows the manufacturer or maintenance company of the inquiry destination to identify the robot 3 and information about the inquiry destination of the robot 3. The information for the manufacturer or maintenance company to identify the robot 3 includes a model name, a serial number, and the like of the robot 3. The information about the inquiry destination includes a URL of the inquiry destination.

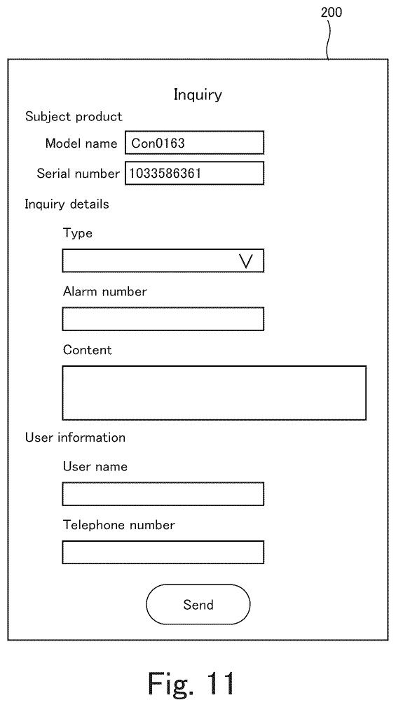

As shown in FIG. 1, the user can obtain the model name, the serial number, and the URL of the inquiry destination of the robot 3 by reading the two-dimensional code displayed on the information processing apparatus 2 with an information processing terminal (hereinafter referred to as a user terminal 21) 21 such as a smartphone. The user terminal 21 is connected to an inquiry server apparatus 22 identified by the URL of the inquiry destination through the Internet 20, receives an inquiry form from the inquiry server apparatus 22, pastes the model name and the serial number of the robot 3 at specific locations of the received inquiry form, and displays the inquiry form in the state where the model name and the serial number are pasted into the existing input fields of the inquiry form (see FIG. 11). The user can complete the inquiry to the inquiry server apparatus 22 by simply entering the remaining items in the inquiry form displayed on the user terminal 21 and transmitting the inquiry form. Since the work of entering the model name and the serial number into the inquiry form can be omitted, it is possible to save the time and effort for the inquiry by the user when an abnormality occurs.

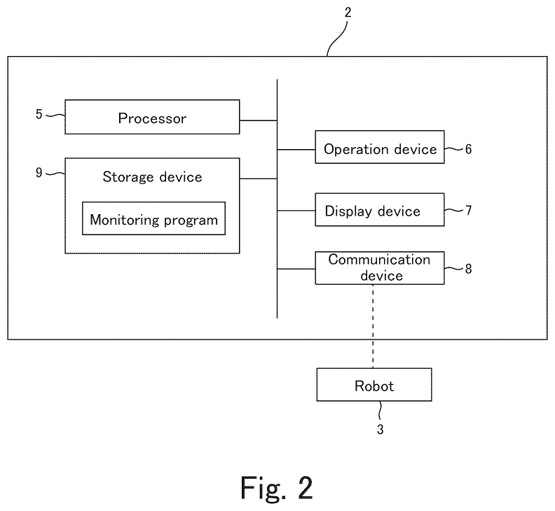

As shown in FIG. 2, the information processing apparatus 2 is configured by connecting hardware such as an operation device 6, a display device 7, a communication device 8, and a storage device 9 to a processor 5 such as a CPU.

The operation device 6 is provided by a keyboard, a mouse, a jog, or the like.

The operation device 6 may be provided by a touch panel that also serves as the display device 7. The user can input a two-dimensional code into the information processing apparatus 2 through the operation device 6. The display device 7 is provided by an LCD or the like. Each screen constituting the monitoring site is displayed on the display device 7. The communication device 8 controls transmission and reception of data to and from the robot 3. Under the control of the communication device 8, the information processing apparatus 2 receives from the robot 3 a signal indicating an operation state and an abnormality signal indicating that an abnormality has occurred.

The abnormality signal includes information indicating that an abnormality has occurred and information indicating the content of the abnormality. The information indicating the content of the abnormality may be text information about the content of the abnormality, an alarm number corresponding to the content of the abnormality, or both. The storage device 9 is provided by an HDD, an SSD, or the like. The storage device 9 stores a monitoring program for monitoring the robot 3.

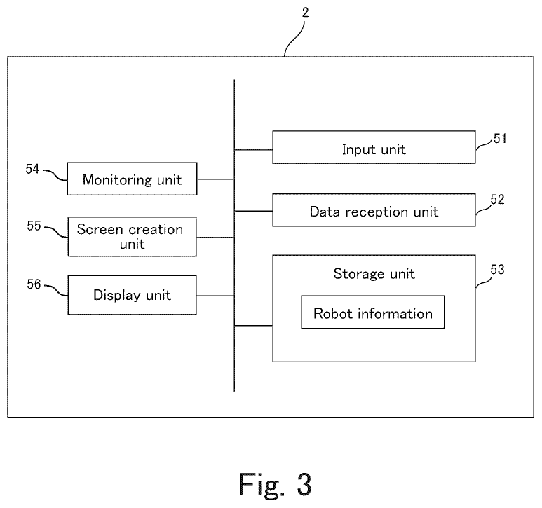

As shown in FIG. 3, when the monitoring program stored in the storage device 9 is executed by the processor 5, the information processing apparatus 2 functions as an input unit 51, a data reception unit 52, a storage unit 53, a monitoring unit 54, a screen creation unit (processing unit) 55, and a display unit 56, and executes monitoring processing.

The input unit 51 has the operation device 6 shown in FIG. 2, and inputs a user operation through the operation device 6 to the information processing apparatus 2. Specifically, the input unit 51 inputs robot information including image data of a two-dimensional code input through a setting screen to the information processing apparatus 2. Note that if the information processing apparatus 2 has a function of reading the two-dimensional code, robot information recorded in the two-dimensional code such as the model name and the manufacturing number among the robot information may be input to the information processing apparatus 2 by reading the two-dimensional code input through the input unit 51.

The data reception unit 52 has the communication device 8 shown in FIG. 2, and receives, from the robot 3, a signal indicating the operation state and an abnormality signal indicating that an abnormality has occurred. The storage unit 53 corresponds to the storage device 9 shown in FIG. 2. The storage unit 53 stores the robot information including the image data of the two-dimensional code input through the input unit 51. In addition, the storage unit 53 stores information, materials, and the like necessary for configuring various screens created by the screen creation unit 55. The monitoring unit 54 monitors the occurrence of an abnormal situation of the robot 3. Specifically, when the monitoring unit 54 receives an abnormality signal from the robot 3, the monitoring unit 54 identifies that an abnormality has occurred in the robot 3, and identifies the content of the abnormality based on the information about the content of the abnormality included in the abnormality signal. The screen creation unit 55 creates a plurality of screens constituting the monitoring site and displays them on the display unit 56. The display unit 56 has the display device 7 shown in FIG. 2, and displays the various screens created by the screen creation unit 55.

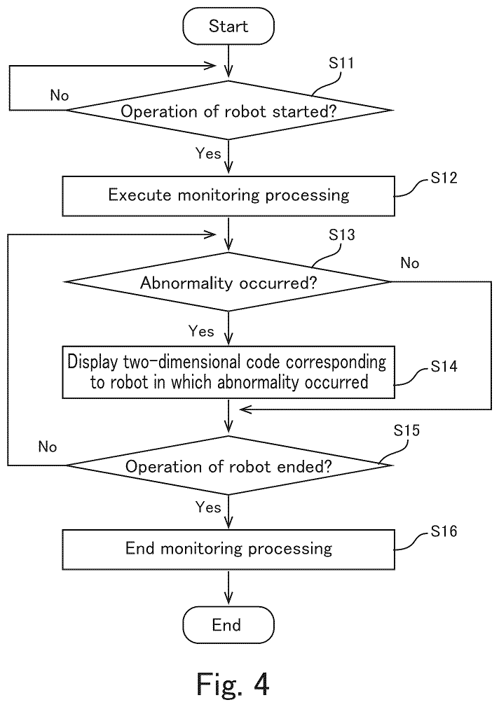

The monitoring processing by the information processing apparatus 2 according to the present embodiment will be described below with reference to FIG. 4. Note that, in the information processing apparatus 2, image data of a two-dimensional code is registered in advance by a user. The robot information including the image data of the two-dimensional code is registered by a user operation on the setting screen displayed on the display unit 56.

The information processing apparatus 2 waits until the monitored robot 3 starts operating (S11; No). When the information processing apparatus 2 receives a signal indicating the operation state from the robot 3, in other words, when the robot 3 starts operating (S11; Yes), the information processing apparatus 2 executes the monitoring processing (S12). Whether or not an abnormal situation has occurred in the robot 3 is monitored until the robot 3 stops (S13; No, S15; No). When an abnormality signal is received from the robot 3 and it is detected that an abnormality has occurred in the robot 3 (S13; Yes), an image of a two-dimensional code corresponding to the robot 3 in which the abnormality has occurred is displayed (S14). In practice, when an abnormal situation occurs in the robot 3, a notification screen including the image of the two-dimensional code is displayed. The information processing apparatus 2 continues to execute the processes of steps S13 and S14 until the operation of the robot 3 is stopped (S15; No) and, upon stop of the operation of the robot 3 (S15; Yes), ends the monitoring processing (S16).

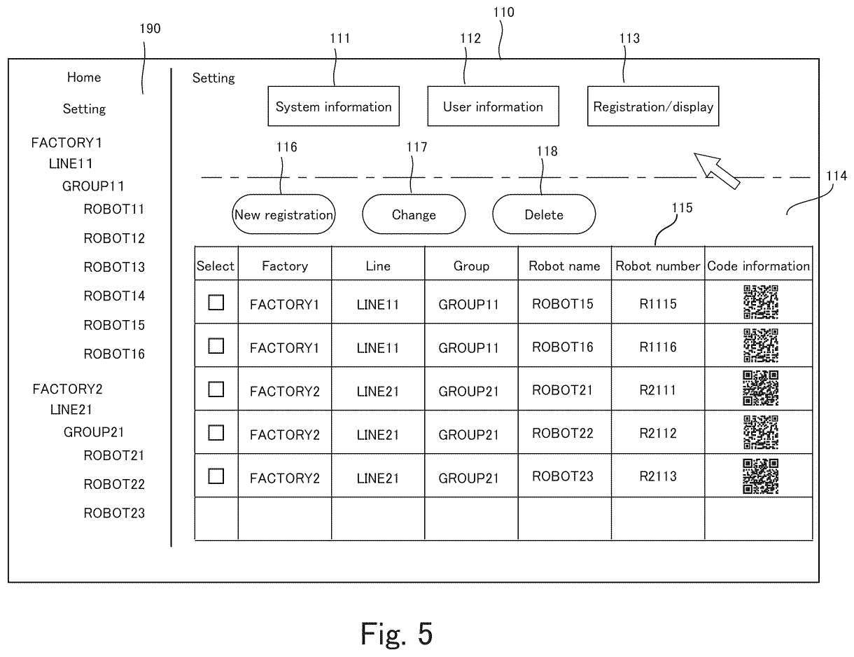

FIG. 5 shows an example of a setting screen 110 created by the screen creation unit 55. The setting screen 110 is provided for setting and confirming various types of information related to the system, the robot, and the user. The setting screen 110 is displayed by clicking “setting” in a navigation tree 190, which is permanently located on each of the screens constituting the monitoring site.

As shown in FIG. 5, the setting screen 110 includes a button 111 for displaying system information, a button 112 for displaying user information, a button 113 for displaying robot information, and an information display area 114. FIG. 5 shows a state in which the button 113 for displaying robot information is clicked, and a management table 115 of robot information, which summarizes robot information, is displayed in the information display area 114. In the information display area 114, a new registration button 116 for newly registering robot information, a change button 117 for changing registered robot information, and a delete button 118 for deleting registered robot information are displayed together with the management table 115 of robot information.

In the management table 115 of robot information, a factory, a line, a group, a robot name, a robot number, and code information are managed in a single record. The robot information “factory” and “line” is information indicating a location where the robot 3 is placed. The robot information “group” is information indicating a management group of the robot 3. The robot information “robot name” and “robot number” is information for individually identifying the robot 3 on the user side. The code information is information indicating the storage location of the image data of the two-dimensional code. The user can register robot information including image data of a two-dimensional code by pressing the new registration button 116. Further, the user can change the robot information of the record for which the selection box is checked, by clicking the change button 117.

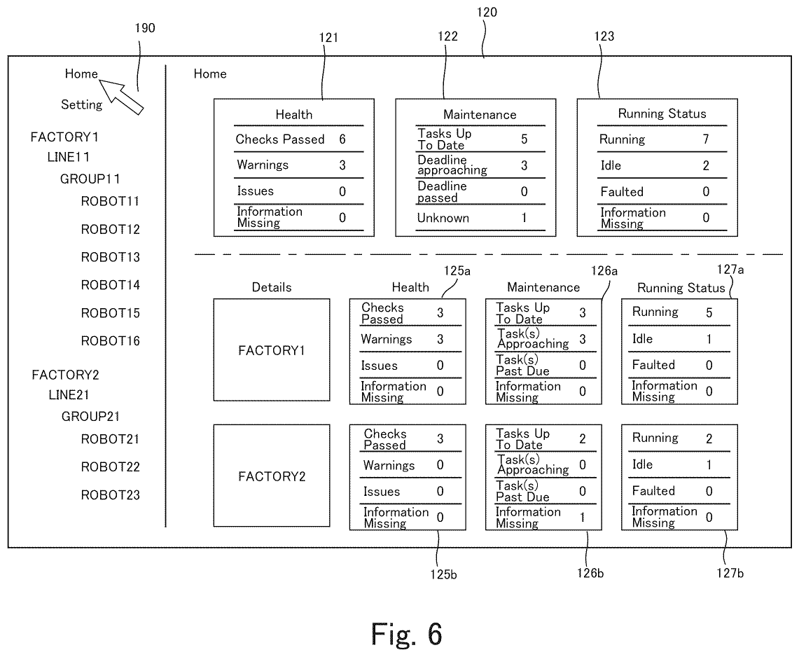

FIG. 6 shows an example of a home screen created by the screen creation unit 55. The home screen 120 is a screen that summarizes the state of the monitored robot 3, and is displayed mainly during the execution of the monitoring processing by the information processing apparatus 2. The home screen 120 is displayed by clicking “home” in the navigation tree 190. As shown in FIG. 5, in the upper area of the home screen 120, a diagnosis result management table 121 that summarizes the diagnosis results of whether or not abnormalities have occurred, a maintenance period management table 122 that summarizes information on the maintenance periods, and an operation state management table 123 that summarizes the Running Status states are displayed for all the monitored robots 3. In the lower area of the home screen 120, a diagnosis result management table 125 (125a, 125b), a maintenance period management table 126 (126a, 126b), and an operation state management table 127 (127a, 127b) for each factory are displayed.

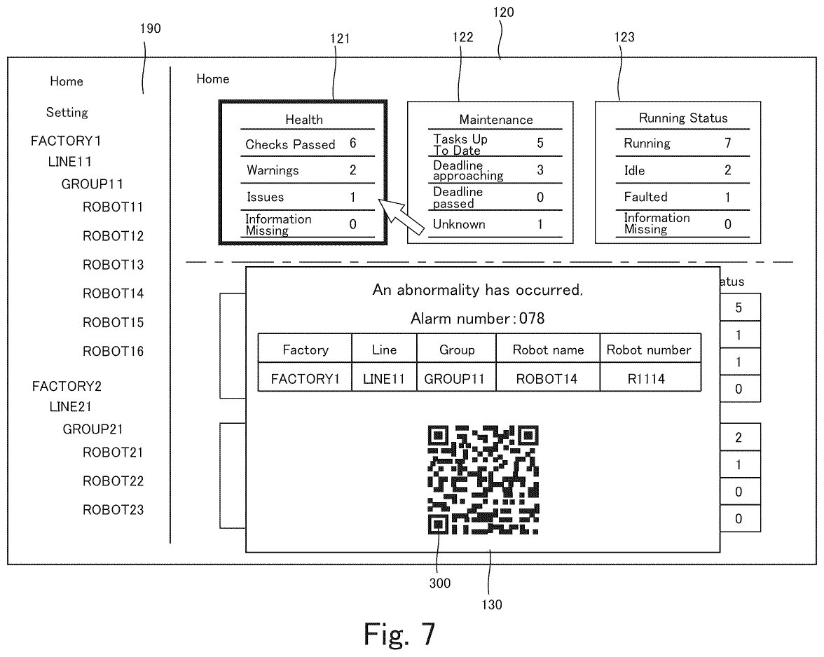

FIG. 7 shows an example of a notification screen created by the screen creation unit 55. The notification screen 130 is a screen for notifying the user that an abnormality has occurred in a robot 3. As shown in FIG. 7, typically, the notification screen 130 automatically pops up when an abnormality occurs in a monitored robot 3 (step S14 in FIG. 4). The notification screen 130 shows text information for notifying the user that an abnormality has occurred in the monitored robot 3, an alarm number corresponding to the content of the abnormality, robot information of the robot 3 in which the abnormality has occurred, and an image 300 of a two-dimensional code. Further, in order to urge the transition to a screen where the content of the abnormality that has occurred in the robot 3 can be confirmed, the display mode of the diagnosis result management table 121 displayed in the upper area of the home screen 120 is changed, and for example, as shown in FIG. 7, the diagnosis result management table 121 is highlighted. When the diagnosis result management table 121 is clicked, a diagnosis result screen is displayed.

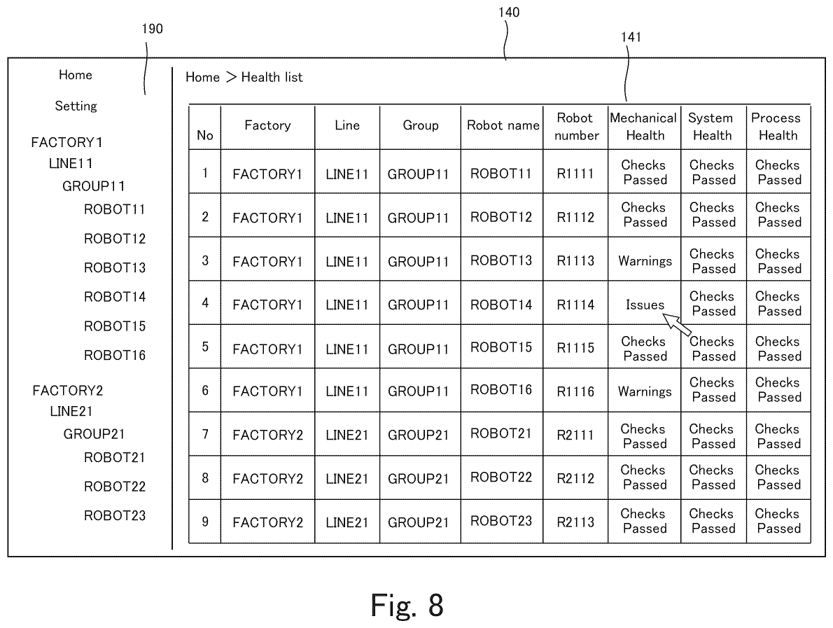

FIG. 8 shows an example of the diagnosis result screen created by the screen creation unit 55. The diagnosis result screen 140 is provided for viewing the diagnosis results of the monitored robots 3. As shown in FIG. 8, the diagnosis result screen 140 shows a diagnosis table 141 summarizing the diagnosis results of all the monitored robots 3. In the diagnosis table 141, a Mechanical Health, a system Health, and a process Health are associated with robot information (factory, line, group, robot name, and robot number). The mechanical Health indicates the diagnosis results of the parts constituting the robot 3 apparatus. The system Health indicates the diagnosis result of the software of the robot 3 apparatus. The process Health indicates the diagnosis result of the work status of the robot 3. For each diagnosis, “Checks Passed” is shown if the diagnosis result is normal, and “Checks failed” is shown if the diagnosis result is abnormal. By viewing the diagnosis result screen 140, the user can grasp in which part of the hardware, the software, or the work of the robot 3 an abnormality has occurred. By clicking “Checks failed” in the diagnosis table 141, a detail screen of the content of the abnormality is displayed. Here, the mechanical diagnosis result of the robot 3 in No. 4 shows that an abnormality has occurred. When the mechanical diagnosis “Checks failed” of the robot 3 in No. 4 is clicked in the diagnosis table 141, a detail screen of the mechanical diagnosis is displayed.

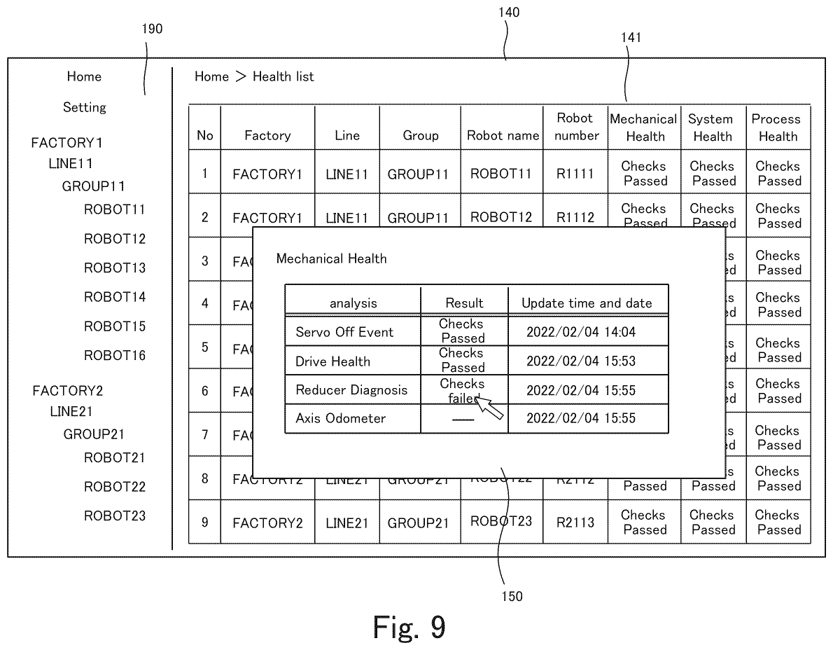

FIG. 9 shows an example of the detail screen of the mechanical diagnosis created by the screen creation unit 55. For example, as shown in FIG. 9, the detail screen 150 of the mechanical diagnosis pops up. The detail screen 150 of the mechanical diagnosis shows an analysis table 151 summarizing “analysis” indicating the analyzed items, “analysis result” indicating the results of the analyses, and “update date and time” indicating the analysis dates and times. By viewing the detail screen 150 of the mechanical diagnosis, the user can grasp the detailed item in which the abnormality has occurred. Here, it is shown that some abnormality has occurred in the reducer. When the analysis result “Checks failed” of the analysis “reducer diagnosis” is clicked, a confirmation screen of the reducer is displayed.

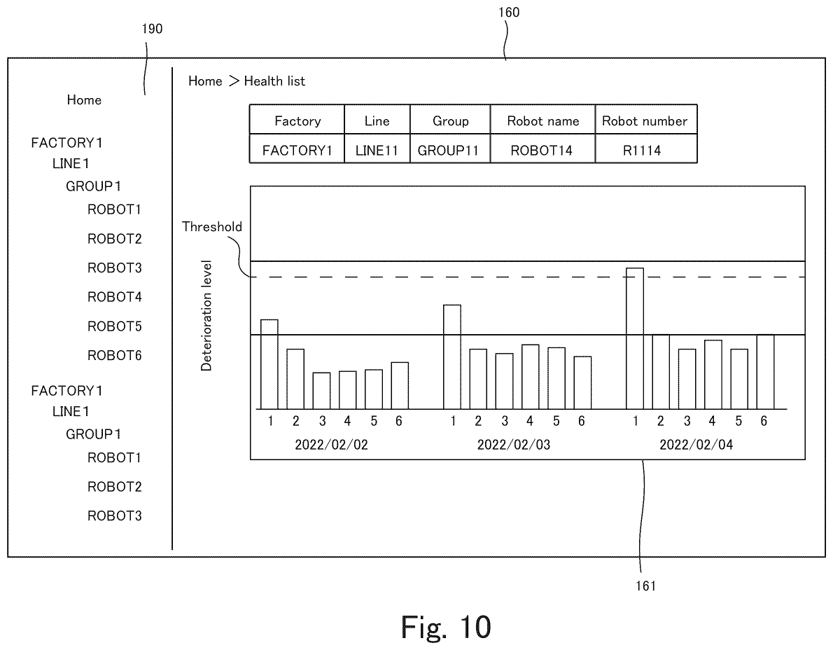

FIG. 10 shows an example of the confirmation screen created by the screen creation unit 55. As shown in FIG. 10, the confirmation screen 160 shows robot information of the target robot 3 and a graph 161 relating to the deterioration level of the reducer mounted on the robot 3. The user can grasp the content of the abnormality of the reducer in detail by viewing the confirmation screen 160 of the reducer.

According to the information processing apparatus 2 of the present embodiment described above, the user can operate the setting screen 110 to register image data of a two-dimensional code in which the robot information necessary at the time of inquiry is recorded. When an abnormality occurs in a monitored robot 3, the information processing apparatus 2 can display an image of a two-dimensional code associated with the robot 3 in which the abnormality has occurred (see FIG. 7). By reading the two-dimensional code displayed on the information processing apparatus 2 with the user terminal 21, the user can have the inquiry screen 200 displayed, which includes an inquiry form in which the model name and the serial number are pasted into existing input fields as robot information, as shown in FIG. 11. The user can complete the inquiry by inputting the content of the inquiry and user information in the inquiry form and sending it. That is, it is not necessary to go to read the two-dimensional code attached to the robot 3 in which the abnormality has occurred or to input the robot information on the user terminal 21 while confirming the robot information as in the prior art, and it is possible to save the time and effort for the inquiry work by the user.

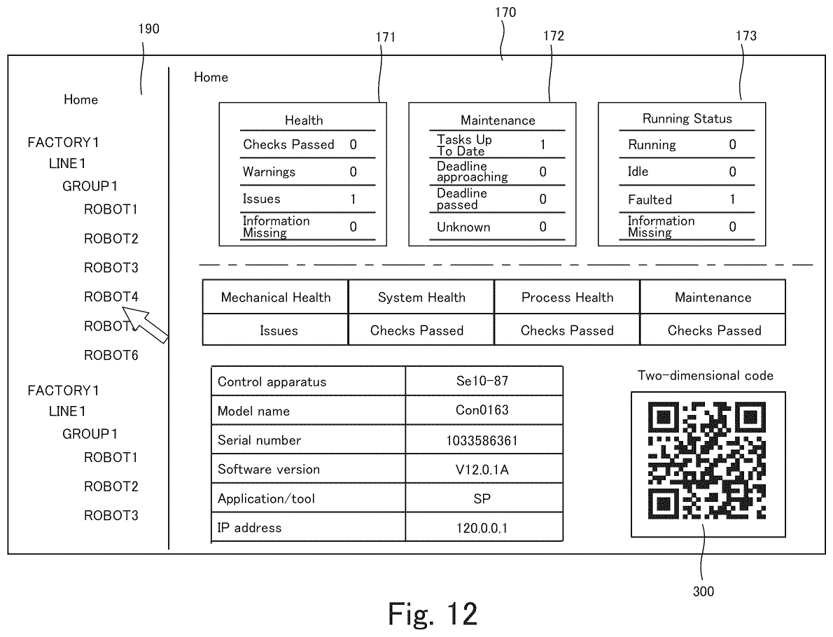

The information processing apparatus 2 according to the present embodiment can display the image of the two-dimensional code when an abnormality occurs in a monitored robot 3. However, the image of the two-dimensional code may be displayed even at a normal time when no abnormality is occurring. For example, the image of the two-dimensional code is displayed on a screen where the state of the corresponding robot 3 can be confirmed. As shown in FIG. 12, by clicking “ROBOT4” in the navigation tree 190, a screen 170 (state confirmation screen 170) is displayed in which the state of “ROBOT4” can be confirmed. The state confirmation screen 170 shows a diagnosis result 171, a maintenance period 172, and an operation state 173 of the corresponding robot 3, and further shows the details of the diagnosis result. The state confirmation screen 170 also shows, as the corresponding robot information, information on the control apparatus, a model name, a serial number, a software version, application/tool information, and an IP address. An image 300 of a two-dimensional code is displayed on the state confirmation screen 170 of “ROBOT4”. By reading the image 300 of the two-dimensional code shown on the state confirmation screen 170, the user can obtain an inquiry form in a state in which the robot information has already been pasted even in a normal time when no abnormality is occurring in the robot 3, and can efficiently make an inquiry about the robot 3.

It has been described that the information processing apparatus 2 according to the present embodiment constitutes the on-premise monitoring system 1 together with the robot 3. However, the information processing apparatus 2 according to the present embodiment may be connectable to an external network 20 such as the Internet. For example, in the case where only the user terminal 21 can be connected to the server apparatus 22 of the inquiry destination through a virtual private network (VPN), the information processing apparatus 2 according to the present embodiment cannot be connected to the server apparatus 22 of the inquiry destination through the external network 20. Therefore, when an abnormality occurs, displaying on the information processing apparatus 2 an image of a two-dimensional code in which the robot information is recorded, causing the user terminal 21 to read the image, and causing the user terminal 21 to take in the information of the robot in which the abnormality has occurred is an effective means for reducing the amount of work for making an inquiry by the user using the user terminal 21.

In the present embodiment, the model name of the robot 3, the serial number, and the URL of the inquiry destination are recorded in the two-dimensional code, but the contents recorded in the two-dimensional code are not limited to these as long as the amount of work for making an inquiry by the user can be reduced. For example, when the URL of the inquiry destination is already known at the user terminal 21, the URL of the inquiry destination does not have to be recorded in the two-dimensional code. Also, the robot information recorded in the two-dimensional code is not limited to the model name and the serial number, and can be information corresponding to the contents of the inquiry form. Therefore, in the present embodiment, a user name and a telephone number may be recorded as user information in the two-dimensional code. By reducing the number of items that need to be entered by the user later in the inquiry form, the time and effort for the inquiry work by the user can be further saved.

When an abnormal situation occurs in the robot 3, the information processing apparatus 2 according to the present embodiment executes a process of displaying an image of a two-dimensional code in which robot information of the robot 3 in which the abnormal situation has occurred is recorded, as a process of supporting an inquiry by the user. However, the process of supporting the inquiry by the user is not limited to this as long as the user can save the time and effort for the inquiry work.

For example, the information processing apparatus 2 may display the robot information (model name, serial number, etc.) of the robot 3 in which the abnormal situation has occurred as text information, instead of displaying the image of the two-dimensional code in which the robot information of the robot 3 in which the abnormal situation has occurred is recorded. Thus, the user can input the items of the inquiry form by operating the user terminal 21 while viewing the robot information displayed on the information processing apparatus 2. Although the process of inputting information into the inquiry form remains the same as before, the user no longer needs to go to see the information attached to the robot 3, in which the abnormal situation has occurred, to confirm the contents to be input into the inquiry form, as before, thus saving the time and effort for the inquiry work by the user.

In addition, the information processing apparatus 2 may have a pasting processing unit (processing unit) that holds the inquiry form and automatically pastes the robot information of the robot 3 in which an abnormal situation has occurred to the existing input fields of the inquiry form when the abnormal situation occurs in the robot 3. Thus, the information processing apparatus 2 can display the inquiry form in which the robot information has been pasted. As in the case where the robot information is displayed, the user can enter the items of the inquiry form by operating the user terminal 21 while viewing the inquiry form displayed on the information processing apparatus 2. Since it is not necessary to go to see the information attached to the robot 3 in which the abnormal situation has occurred, it is possible to save the time and effort for the inquiry work by the user.

If the information processing apparatus 2 can be connected to the external network 20 such as the Internet, the information processing apparatus 2 can transmit the inquiry form in which the robot information has been pasted to the user terminal 21. The user can complete the inquiry work by simply entering the remaining items in the inquiry form displayed on the user terminal 21 and transmitting the inquiry form. This clearly saves the user's time and effort compared to when the user enters all the items of the inquiry form.

If the information processing apparatus 2 can be connected to the external network 20 such as the Internet, the information processing apparatus 2 can transmit the inquiry form in which the robot information has been pasted to the server apparatus 22 of the inquiry destination. This eliminates the need for the user to create an inquiry form, thereby saving the time and effort for the inquiry work by the user.

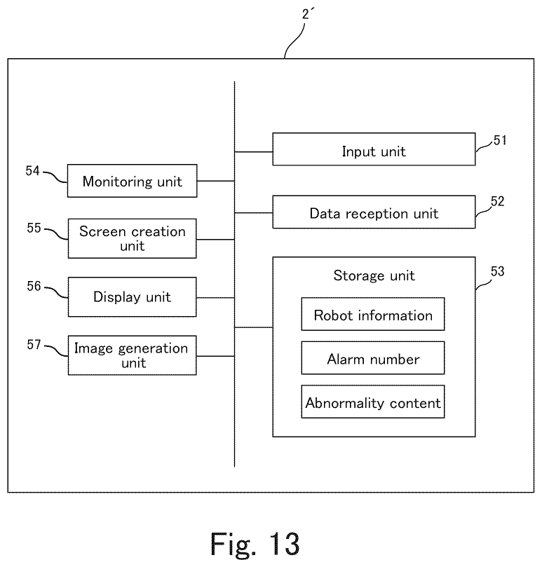

FIG. 13 is a functional block diagram of an information processing apparatus according to a modification of the present embodiment. An information processing apparatus 2′ according to the modification of the present embodiment has a function of creating a two-dimensional code. Here, redundant descriptions will be omitted, and only the portions relevant to the creation of the two-dimensional code will be described.

The storage unit 53 stores information necessary for creating the two-dimensional code. The information necessary for creating the two-dimensional code includes robot information, a URL of an inquiry destination, an alarm number, an abnormality content, and the like. Of course, at least one of these pieces of information needs to be recorded in the two-dimensional code, and the contents corresponding to the inquiry form can be recorded. For example, a user name, a telephone number, and the like may be recorded in the two-dimensional code.

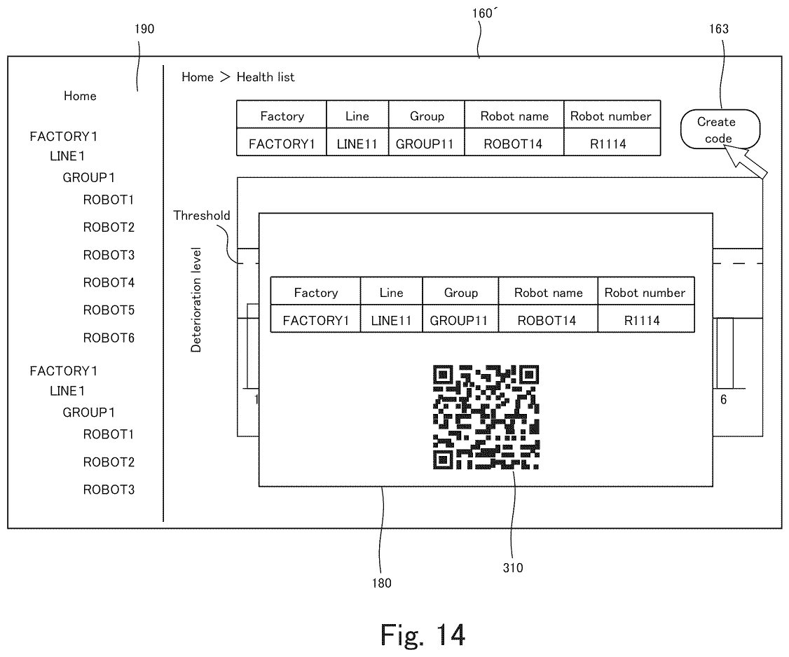

The image generation unit 57 generates image data of a two-dimensional code when an abnormal situation occurs in a robot 3. Specifically, the image generation unit 57 automatically generates a two-dimensional code in accordance with a predetermined rule based on information necessary for creating the two-dimensional code, and generates image data of the two-dimensional code. The image of the two-dimensional code generated by the image generation unit 57 is displayed on the notification screen 130 shown in FIG. 7. Note that the processing by the image generation unit 57 may be executed in response to a user operation on the monitoring site. For example, as in the confirmation screen of the reducer shown in FIG. 14, a code creation button 163 is displayed on a screen 160′ for confirming a specific abnormality content, and a two-dimensional code is created in accordance with a click of the code creation button 163. An image 310 of the created two-dimensional code is displayed on the two-dimensional code display screen 180.

According to the information processing apparatus 2′ of the modification of the present embodiment, the following effects are achieved. That is, in the information processing apparatus 2 according to the present embodiment, the two-dimensional code must be registered in advance; therefore, the information that can be included in the two-dimensional code is only fixed information such as robot information. On the other hand, since the information processing apparatus 2′ according to the modification has the function of creating a two-dimensional code, the two-dimensional code may include contents, such as an alarm number at the time of occurrence of an abnormality and an abnormality content, that need to be input in the inquiry form and change time to time. By reading the displayed image of the two-dimensional code created by the information processing apparatus 2′ with the user terminal 21, the user can display on the user terminal 21 an inquiry form in which not only the robot information but also the alarm number and the abnormality content have already been pasted. Compared with the information processing apparatus 2 according to the present embodiment, the number of items that need to be entered by the user later can be reduced, the time and effort for the inquiry work by the user can be further reduced.

The following appendixes are further disclosed with respect to the present embodiments and modifications.

### (Appendix 1)

An information processing apparatus 2 is connected to an industrial machine 3, and includes a monitoring unit 54 for monitoring the occurrence of an abnormal situation of the industrial machine 3, and a processing unit 55 for executing a support process of supporting an inquiry by a user when an abnormality of the industrial machine 3 is detected.

### (Appendix 2)

The information processing apparatus 2 described in Appendix 1 further includes a display unit 56 and a storage unit 53 for storing image data relating to a readable code in which information relating to the industrial machine 3 is recorded, and the processing unit 55 executes a process of displaying the stored image data on the display unit 56 as the support process.

### (Appendix 3)

The information relating to the industrial machine 3 described in Appendix 2 includes identification information for identifying the industrial machine 3.

### (Appendix 4)

The information relating to the industrial machine 3 described in Appendix 3 includes a URL of an inquiry destination together with the identification information.

### (Appendix 5)

The information processing apparatus 2 described in Appendix 1 further includes a display unit 56 and a storage unit 53 for storing information relating to the industrial machine 3, and the processing unit 55 executes a process of displaying the information relating to the industrial machine 3 on the display unit 56 as the support process.

### (Appendix 6)

The information processing apparatus 2 described in Appendix 1 further includes a storage unit 53 for storing information relating to the industrial machine 3, and the processing unit 55 executes a process of pasting the stored information relating to the industrial machine 3 at a predetermined location of the inquiry form as the support process.

### (Appendix 7)

The information processing apparatus 2 described in any one of Appendixes 1 to 6 is configured on an on-premise environment.

### (Appendix 8)

An information processing device 2 is connected to an industrial machine 3 and includes a storage unit 53 for storing information relating to the industrial machine 3, a display unit 56, a generation unit 57 for generating image data relating to a readable code in which the information relating to the industrial machine 3 is recorded, and a processing unit 55 for displaying the generated image data on the display unit 56.

### (Appendix 9)

The information relating to the industrial machine 3 described in Appendix 8 includes identification information for identifying the industrial machine 3 and a URL of an inquiry destination, and the generation unit 57 generates image data from the identification information and the URL of the inquiry destination.

### (Appendix 10)

The generation unit 57 generates image data from information on a content of the abnormality of the industrial machine 3, together with the identification information and the URL of the inquiry destination.

While embodiments of the present disclosure have been described in detail, the present disclosure is not limited to the individual embodiments described above. These embodiments may be subjected to various additions, substitutions, modifications, partial deletions, etc., without departing from the gist of the invention or the idea and spirit of the present invention as derived from the contents described in the claims and their equivalents. For example, in the above-described embodiments, the order of the operations and the order of the processes are shown as examples, and the present invention is not limited thereto. The same applies to the case where numerical values or formulas are used in the description of the above-described embodiments.

1. An information processing apparatus connected to an industrial machine, comprising:
a monitoring unit for monitoring an occurrence of an abnormal situation of the industrial machine; and
a processing unit for executing a support process of supporting an inquiry by a user when an abnormality of the industrial machine is detected.

2. The information processing apparatus according to claim 1, further comprising:
a display unit; and
a storage unit for storing image data relating to a readable code in which information relating to the industrial machine is recorded, wherein
the processing unit executes a process of displaying the stored image data on the display unit as the support process.

3. The information processing apparatus according to claim 2, wherein the information relating to the industrial machine includes identification information for identifying the industrial machine.

4. The information processing apparatus according to claim 3, wherein the information relating to the industrial machine includes a URL of an inquiry destination together with the identification information.

5. The information processing apparatus according to claim 1, further comprising:
a display unit; and
a storage unit for storing information relating to the industrial machine, wherein
the processing unit executes a process of displaying the information relating to the industrial machine on the display unit as the support process.

6. The information processing apparatus according to claim 1, further comprising:
a storage unit for storing information relating to the industrial machine, wherein
the processing unit executes a process of pasting the stored information relating to the industrial machine at a predetermined location on an inquiry form as the support process.

7. The information processing apparatus according to claim 1, wherein the information processing apparatus is configured on an on-premise environment.

8. An information processing apparatus connected to an industrial machine, comprising:
a storage unit for storing information relating to the industrial machine;
a display unit;
a generation unit for generating image data relating to a readable code in which the information relating to the industrial machine is recorded; and
a processing unit for displaying the generated image data on the display unit.

9. The information processing apparatus according to claim 8, wherein the information relating to the industrial machine includes identification information for identifying the industrial machine and a URL of an inquiry destination, and the generation unit generates the image data from the identification information and the URL of the inquiry destination.

10. The information processing apparatus according to claim 9, wherein the generation unit generates the image data from information relating to a content of an abnormality of the industrial machine, together with the identification information and the URL of the inquiry destination.
